(19) United States
(12) Patent Application Publication
(10) Pub. No.: US 2024/0232931 A9
(43) Pub. Date: Jul. 11, 2024

(54) CONTROL METHOD, NON-TRANSITORY COMPUTER READABLE STORAGE MEDIUM, AND SERVER DEVICE

(71) Applicant: Panasonic Intellectual Property Corporation of America, Torrance, CA (US)

(72) Inventor: Nobuaki TASAKI, Osaka (JP)

(73) Assignee: Panasonic Intellectual Property Corporation of America, Torrance, CA (US)

(21) Appl. No.: 18/402,491

(22) Filed: Jan. 2, 2024

Related U.S. Application Data
(63) Continuation of application No. PCT/JP2022/026742, filed on Jul. 5, 2022.

(30) Foreign Application Priority Data
Jul. 6, 2021 (JP) 2021-112337

(51) Int. Cl. G06Q 30/0207; G06Q 50/43

(52) U.S. Cl. CPC G06Q 30/0224; G06Q 50/43

(57) ABSTRACT

A control method includes, by a computer: acquiring first information indicating a history of movement between hubs using a plurality of vehicles by a plurality of users; accepting second information indicating a request to move a vehicle from one hub to another hub; outputting a price of a reward to be paid to each of the users when a request indicated by the second information is achieved according to a matching rate calculated as a degree of coincidence between the first information of each user and the second information; and notifying of the second information and information indicating the reward of each user.

### TECHNICAL FIELD

The present disclosure relates to a technique for rearranging a vehicle in a system that allows a plurality of users to share a plurality of vehicles arranged in a plurality of hubs.

### BACKGROUND ART

Conventionally, a sharing service that allows a plurality of users to share a plurality of vehicles arranged in a plurality of hubs has been known. In this service, usually, a contract worker performs work of charging a vehicle, replacing a rechargeable battery, or what is called rearrangement of a vehicle for moving the vehicle to a hub short of vehicles. However, there is a problem that a ratio of cost required for these pieces of work to sales is high, which squeezes earnings.

In response to such a problem, for example, Patent Literature 1 proposes to acquire a movement history of each user in a shared vehicle, and transmit movement soliciting information for soliciting movement work of a vehicle to another hub to the user having a history of movement in a time zone of the movement work. Further, Patent Literature 1 proposes to include, in the movement soliciting information, information indicating that a consideration corresponding to demand for movement work is paid to the user who performs the movement work.

Patent Literature 2 proposes to calculate a walking range in which the user moves on foot to rent a shared vehicle based on a use history of each station by a plurality of users, and provide a high-value incentive privilege in a case where the user uses a station at a position beyond the walking range.

Patent Literature 3 proposes to identify a target station whose use frequency is equal to or less than a predetermined value based on a past use history of each station by the user, and, in a case where the user selects a station that is not the target station, output information on the selected station and information on the target station, and further output a route passing near the target station as a route to the selected station.

However, in the conventional technique, there has been a problem that an achievement rate of movement work of a vehicle to another hub is not improved unless a reward to be paid when the movement work is achieved is set to a high price.

### CITATION LIST

### Patent Literature

Patent Literature 1: JP 2009-301150 A
Patent Literature 2: JP 2016-85509 A
Patent Literature 3: JP 6561483 B

### SUMMARY OF INVENTION

The present disclosure has been made to solve the above problem, and an object of the present disclosure is to present a control method, a non-transitory computer readable storage medium, and a server device capable of increasing an achievement rate of movement work of a vehicle to another hub at low cost.

A control method according to one aspect of the present disclosure is a control method in a system that allows a plurality of users to share a plurality of vehicles arranged in a plurality of hubs, the control method including, by a computer, acquiring first information indicating a history of movement between hubs using the plurality of vehicles by the plurality of users, accepting second information indicating a request to move a vehicle from one hub to another hub, outputting a price of a reward to be paid to each of the users when a request indicated by the second information is achieved, in accordance with a matching rate calculated as a degree of coincidence between the first information of each user and the second information, and notifying the second information and information indicating the reward of each user.

### BRIEF DESCRIPTION OF DRAWINGS

FIG. 1 is a diagram illustrating an example of an overall configuration of a vehicle sharing system.

FIG. 2 is a flowchart illustrating an example of processing of storing movement history information.

FIG. 3 is a flowchart illustrating an example of processing performed in the vehicle sharing system in a case where movement request information is acquired.

### DESCRIPTION OF EMBODIMENTS

### Background of Present Disclosure

As described above, conventionally, in a sharing service in which a plurality of vehicles arranged in a plurality of hubs are shared by a plurality of users, there is a problem that cost is required for work of rearranging a vehicle to another hub.

In response to this problem, Patent Literature 1 proposes to notify the user of information for soliciting movement work of a vehicle to another hub and information for paying a consideration corresponding to demand for the movement work. However, in the technique of Patent Literature 1, there is a problem that an achievement rate of movement work of a vehicle to another hub is not improved unless a consideration paid when the movement work of the vehicle is achieved is set to a high price.

The techniques of Patent Literatures 2 and 3 are to reduce an operation rate between hubs in order to reduce movement work itself of a vehicle to another hub, and improvement of an achievement rate of movement work of a vehicle to another huh and cost required for the improvement are not mentioned.

For example, there is assumed to be a request to move a vehicle arranged at a first hub near a university to a second hub near a station. In this case, a university student who is the user of a sharing service can be predicted to move the vehicle from the university to the station, it is considered that a request for moving the vehicle from the first hub to the second hub can be notified to the university student, and the request can be achieved by the university student at no cost.

As described above, the present inventor has intensively studied a technique for increasing an achievement rate of movement work of a vehicle to another hub at low cost, and has achieved each aspect of the present disclosure described below.

(1) A control method according to one aspect of the present disclosure is a control method in a system that allows a plurality of users to share a plurality of vehicles arranged in a plurality of hubs, the control method including, by a computer, acquiring first information indicating a history of movement between hubs using the plurality of vehicles by the plurality of users, accepting second information indicating a request to move a vehicle from one hub to another hub, outputting a price of a reward to be paid to each of the users when a request indicated by the second information is achieved, in accordance with a matching rate calculated as a degree of coincidence between the first information of each user and the second information, and notifying of the second information and information indicating the reward of each user.

According to the present configuration, the second information and information indicating a reward to be paid to each user when a request indicated by the second information is achieved are notified. For this reason, in the present configuration, it is possible to request each user to move a vehicle between hubs indicated by the second information for a notified reward.

Further, a price of a reward notified to each user is output according to a matching rate calculated as a degree of coincidence between the first information of each user and the second information. For this reason, for example, it is possible to request the user who performs movement of a vehicle having a high degree of coincidence with movement content of a vehicle indicated by the second information to move the vehicle between hubs indicated by the second information for a reward at a lower price than that for the user who performs movement of a vehicle having a low degree of coincidence with the movement content of a vehicle indicated by the second information. By the above, in the present configuration, a price of a reward can be kept low, and an achievement rate of a request for moving a vehicle can be increased at low cost.

(2) The control method according to (1) may further include identifying one or more users having a history of movement from the one hub to the other hub based on the first information, and calculating, as the matching rate, for each of the one or more users, how high a degree of coincidence between movement content of a vehicle by each user based on the first information and the movement content of a vehicle based on the second information is among one or more of the users. In the notification, each of one or more of the users may be notified of the second information and information indicating the reward of each user.

According to the present configuration, a price of a reward notified to each of one or more of the users can be made lower for the user with a higher matching rate among one or more of the users, for example. In this case, among one or more of the users, the user having a relatively high possibility of moving a vehicle with the same content as movement content of a vehicle indicated by the second information can be requested to move a vehicle between hubs indicated by the second information with a reward at a lower price.

(3) In the control method according to (2), a price of the reward may be lower price as the matching rate is higher.

In the present configuration, a price of a reward notified to one or more of the users becomes lower price for the user with a higher matching rate among one or more of the users. Therefore, among one or more of the users, the user having a relatively high possibility of moving a vehicle with the same content as movement content of a vehicle indicated by the second information can be requested to move a vehicle between hubs indicated by the second information for a reward at a lower price.

(4) In the control method according to (2), in the notification, a provisional price may be notified as a price of the reward, and further, in a case where information indicating acceptance of a request indicated by the second information at a price equal to or less than the provisional price is received from a predetermined number or more of users within a certain period from the notification, a lowest price among received prices equal to or less than the provisional price may be determined as a price of the reward, and the second information and information indicating the reward may be notified to the user who transmits information indicating acceptance of a request indicated by the second information at the lowest price.

In the present configuration, the second information and information indicating a reward at a lowest price equal to or less than a provisional price are notified to the user who transmits information indicating acceptance of a request indicated by the second information at the lowest price. For this reason, movement of a vehicle indicated by the second information can be achieved at low cost.

(5) The control method according to (4) may further include acquiring third information indicating a reaction when the plurality of users receive a notification of the second information and information indicating the reward for each user, calculating, for each of the plurality of users, a reaction sensitivity indicating how high among the plurality of users a probability indicating that each user has an intention of achieving a request indicated by the second information is when the plurality of users receive a notification of a predetermined standard price as a price of the reward based on the third information, and calculating, for each of the plurality of users, a reaction rate that is a probability that the user is predicted to have an intention of achieving a request indicated by the second information, based on the matching rate and the reaction sensitivity. In the notification, a user who has any one of the reaction rate, the matching rate, and the reaction sensitivity equal to or more than a predetermined value among one or more of the users is notified of the second information and information indicating the reward.

According to the present configuration, it is possible to avoid notifying the user who is predicted to have no intention of achieving a request indicated by the second information, the user having all of a reaction rate, a matching rate, and a reaction sensitivity less than a predetermined value, of the second information and the information indicating a reward.

(6) The control method according to (1) may further include acquiring third information indicating a reaction when the plurality of users receive a notification of the second information and information indicating the reward for each user, and calculating, for each of the plurality of users, a reaction sensitivity indicating how high among the plurality of users a probability indicating that each user has an intention of achieving a request indicated by the second information is when the plurality of users receive a notification of a predetermined standard price as a price of the reward based on the third information. In the output of a price of the reward, a price of the reward may be further determined to be lower price as the reaction sensitivity of each user is higher.

According to the present configuration, a price of a reward is determined to be lower price for the user who has a higher reaction sensitivity among one or more users who have moved a vehicle from the one hub to the other hub. For this reason, it is possible to request the user having a relatively high possibility of indicating an intention to achieve a request indicated by the second information among the one or more users to move a vehicle between hubs indicated by the second information with a reward at a lower price. By the above, in the present configuration, a price of a reward can be kept low, and an achievement rate of a request for moving a vehicle can be increased at low cost.

(7) In the control method according to (1) or (6), in the acquisition of the first information, in a case where a user passes through an intermediate hub existing within a predetermined distance from a vehicle while moving from the one hub to the other hub by using that vehicle, information indicating that the user moves from the one hub to the other hub by using that vehicle and information indicating that the user moves from the one hub to the intermediate hub by using that vehicle may be acquired as the first information.

According to the present configuration, not only in a case where the second information requesting to move a vehicle from the one hub to the other hub is accepted, but also in a case where information requesting to move a vehicle from the one hub to the intermediate hub is accepted, the information can be notified to the user having a history of moving a vehicle from the one hub to the other hub.

(8) In the control method according to (7), in the acquisition of the first information, in a case where a user passes through an intermediate hub existing within a predetermined distance from a vehicle while moving from the one hub to the other hub by using that vehicle, information indicating that the user moves from the intermediate hub to the other hub by using that vehicle may be further acquired as the first information.

According to the present configuration, even in a case where information requesting to move a vehicle from the intermediate hub to the other hub is accepted, the information can be notified to the user who has moved a vehicle from the one hub to the other hub.

(9) In the control method according to any one of (1) and (6) to (8), the first information may include information indicating a departure hub and a departure date and time of a vehicle used by the plurality of users for movement, and information indicating an arrival hub and an arrival date and time of a vehicle used by the plurality of users for movement, the second information may further include information indicating a time zone in which a vehicle is moved, and the movement content of a vehicle may include a use time zone, a departure hub, and an arrival hub of a vehicle.

According to the present configuration, a use time zone of a vehicle can be grasped from a departure date and time and an arrival date and time of a vehicle used by each user for movement included in the first information, and the grasped use time zone of a vehicle and a time zone for moving a vehicle included in the second information can be compared. Further, a departure hub and an arrival hub of a vehicle used for movement by each user included in the first information can be compared with the one hub which is a departure hub of a vehicle indicated by the second information and the other hub which is an arrival hub of a vehicle indicated by the second information.

From these comparison results, it is possible to appropriately calculate a degree of coincidence between a use time zone, a departure hub, and an arrival hub of a vehicle, which are movement content of a vehicle by each user, and a use time zone, a departure hub, and an arrival hub of a vehicle, which are movement content of a vehicle indicated by the second information. As a result, a matching rate of each user included in the one or more users can be appropriately calculated.

(10) In the control method according to (9), the movement content of a vehicle may further include at least one of weather when a vehicle moves, a date category of a movement date of a vehicle, a month when a vehicle moves, and a vehicle type of a vehicle, and the date category may be information indicating which of seven days of a week from Sunday to Saturday or a national holiday the date is.

According to the present configuration, a degree of coincidence between movement content of a vehicle by each user and movement content of a vehicle indicated by the second information can be more appropriately calculated by further using a comparison result between at least one of weather when a vehicle moves, a date category of a day when a vehicle moves, a month when a vehicle moves, and a vehicle type of a vehicle, which can be grasped based on the first information, and at least one of weather when a vehicle moves, a date category of a day when a vehicle moves, a month when a vehicle moves, and a vehicle type of a vehicle used for movement, which can be grasped based on the second information, corresponding to the at least one. As a result, a matching rate of each user included in the one or more users can be more appropriately calculated.

(11) A non-transitory computer readable storage medium according to another aspect of the present disclosure is a non-transitory computer readable storage medium storing a program that causes a computer included in a system that allows a plurality of users to share a plurality of vehicles arranged in a plurality of hubs to function as: an acquisition unit that acquires first information indicating a history of movement between hubs using the plurality of vehicles by the plurality of users, an acceptance unit that accepts second information indicating a request for moving a vehicle from one hub to another hub, a determination unit that outputs a price of a reward to be paid to each of the users when a request indicated by the second information is achieved according to a matching rate calculated as a degree of coincidence between the first information of each user and the second information, and a notification unit that notifies of the second information and information indicating the reward of each user.

According to the present configuration, the same effects as those of the control method can be obtained. It is needless to say that the present disclosure can allow such a computer program to be distributed using a computer-readable non-transitory recording medium such as a CD-ROM, or via a communication network such as the Internet.

(12) A server device according to another aspect of the present disclosure is a server device included in a system that allows a plurality of users to share a plurality of vehicles arranged in a plurality of hubs, the server device including an acquisition unit that acquires first information indicating a history of movement between hubs using the plurality of vehicles by the plurality of users, an acceptance unit that accepts second information indicating a request for moving a vehicle from one hub to another hub, a determination unit that outputs a price of a reward to be paid to each of the users when a request indicated by the second information is achieved according to a matching rate calculated as a degree of coincidence between the first information of each user and the second information, and a notification unit that notifies of the second information and information indicating the reward of each user.

According to the present configuration, the same effects as those of the control method can be obtained.

Note that each of embodiments described below describes a specific example of the present disclosure. Numerical values, shapes, constituents, steps, order of steps, and the like shown in the embodiments below are merely examples, and are not intended to limit the present disclosure. Further, among constituents in the embodiments below, a constituent that is not described in an independent claim indicating the most significant concept will be described as an optional constituent. Further, in all the embodiments, content of each of the embodiments can be combined.

Hereinafter, embodiments of the present disclosure will be described with reference to the drawings.

### First Embodiment

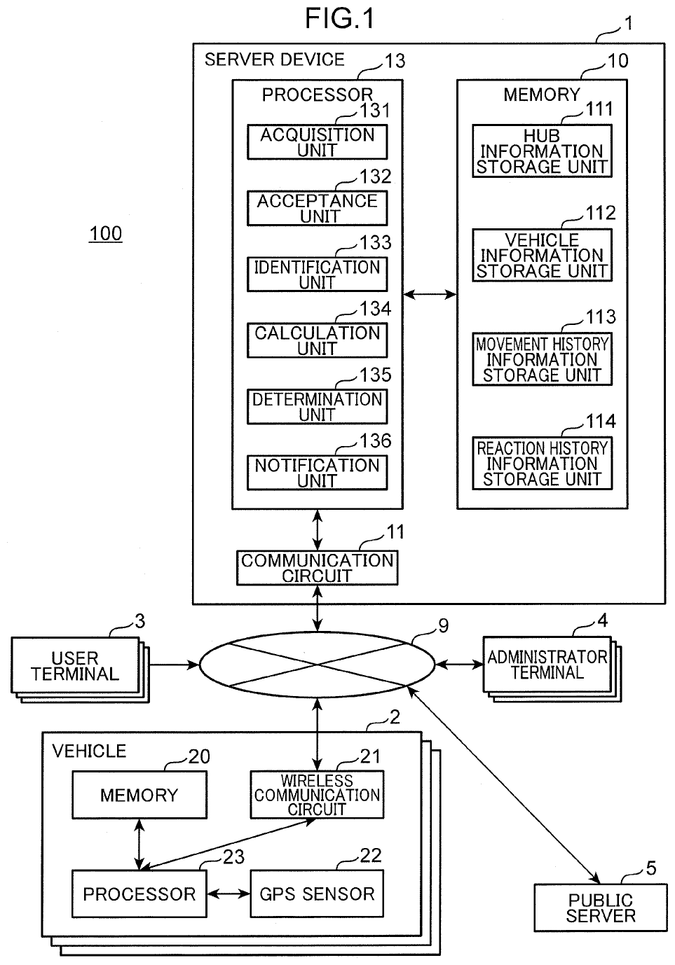

FIG. 1 is a diagram illustrating an example of an overall configuration of a vehicle sharing system 100 (system). The vehicle sharing system 100 includes a plurality of vehicles 2 arranged in a plurality of hubs, a server device 1 for providing a sharing service that causes a plurality of users to share the plurality of vehicles 2, a plurality of user terminals 3 used by a plurality of users of a sharing service, and a plurality of administrator terminals 4 used by a plurality of administrators of a sharing service. The hub is a place where the user rents the vehicle 2 and a place where the user returns the vehicle 2.

The vehicle 2, the user terminal 3, and the administrator terminal 4 are communicably connected to the server device 1 via a network 9. The network 9 includes, for example, a wide area network (WAN) including the Internet, a mobile phone communication network, and the like.

As the vehicle 2, for example, a vehicle that can be moved by driving of the user, such as an automobile, a motorcycle, a motorized bicycle, or an electric bicycle, is employed. As the user terminal 3 and the administrator terminal 4, an information processing device capable of communicating with an external device via the network 9 such as a smartphone, a tablet terminal, and a personal computer is employed. As the server device 1, a cloud server including one or more computers including a processor such as a central processing unit (CPU), a memory, and a communication circuit that communicates with an external device via the network 9 is employed.

Note that the server device 1, the vehicle 2, the user terminal 3, and the administrator terminal 4 are communicably connected to a public server 5 via the network 9. The public server 5 returns necessary public information in response to an inquiry from the server device 1, the vehicle 2, the user terminal 3, and the administrator terminal 4. The public information includes, for example, information indicating a season corresponding to a designated date and time, information indicating weather at a designated date and time, information indicating a date category of a designated date, and the like. The date category is information indicating which of seven days of the week from Sunday to Saturday or a national holiday the date is.

In the vehicle sharing system 100, based on information acquired by the server device 1 from the vehicle 2, the administrator terminal 4, and the public server 5 via the network 9, the server device 1 notifies, via the network 9, the user terminal 3 of information indicating a request for moving the vehicle 2 from one hub to another hub (hereinafter, movement request information (second information)) and information indicating a reward to be paid when a request indicated by the movement request information is achieved.

The information indicating a reward includes information indicating a type of a reward and information indicating a price of a reward. The type of a reward includes, for example, reward money, a point, a service ticket, a coupon, and the like. In a case where the type of a reward is reward money, a price of the reward is an amount of reward money. In a case where the type of a reward is a point, a price of the reward is the number of points. In a case where the type of a reward is a service ticket, a price of the reward is the number of times a target service of the service ticket can be used for free. In a case where the type of a reward is a coupon, a price of the reward is a use price of a target service of the coupon after a discount by the coupon. Hereinafter, the type of a reward is assumed to be reward money, and a price of the reward is an amount of reward money.

Further, the vehicle sharing system 100 manages information indicating a reaction of the user to a request indicated by the movement request information and transmitted from the user terminal 3 that receives the notification to the server device 1 via the network 9.

The movement request information includes information indicating a vehicle type of the vehicle 2 to be moved, a departure hub and an arrival hub of the vehicle 2, a time zone (hereinafter, movement time zone) in which the vehicle 2 is moved, and a desired reaction rate indicating how much movement of the vehicle 2 is desired to be achieved. The movement time zone also includes a date on which the vehicle 2 is moved.

Hereinafter, a detailed configuration of each of the vehicle 2 and the server device 1 will be described.

The vehicle 2 includes a memory 20, a wireless communication circuit 21, a global positioning system (GPS) sensor 22, and a processor 23. The vehicle 2 further includes an operation device for allowing the user to perform various types of operation in order to use the vehicle 2, and a display for displaying various types of information. Further, the vehicle 2 may further include a battery for driving the vehicle 2.

The memory 20 includes, for example, a nonvolatile rewritable semiconductor memory such as a flash memory. The memory 20 stores a program and the like executed by the processor 23. The wireless communication circuit 21 performs wireless communication with the server device 1 via the network 9. The GPS sensor 22 detects a current position.

The processor 23 includes a central processing unit (CPU). The processor 23 performs predetermined processing by executing a program stored in the memory 20.

For example, the processor 23 transmits various types of information and data to the server device 1 using the wireless communication circuit 21. Specifically, while the vehicle 2 is driven, the processor 23 periodically (for example, every 30 seconds) transmits state information indicating a current state of the vehicle 2 to the server device 1.

The state information includes information indicating a current date and time (hereinafter, current date and time information), identification information of the vehicle 2, and information indicating a current position of the vehicle 2 detected by the GPS sensor 22.

The server device 1 includes a memory 10, a communication circuit 11, and a processor 13.

The memory 10 includes, for example, a nonvolatile rewritable semiconductor memory such as a flash memory, a hard disk drive (HDD), or the like. The memory 10 stores a program executed by the processor 13. Further, the memory 10 includes a hub information storage unit 111, a vehicle information storage unit 112, a movement history information storage unit 113, and a reaction history information storage unit 114.

The hub information storage unit 111 stores information (hereinafter, huh information) related to a plurality of hubs. The hub information includes identification information of a hub, information indicating a position of a hub, information indicating the number of the vehicles 2 currently arranged in a hub (hereinafter, current number information), information indicating the minimum number of the vehicles 2 to be arranged in a hub (hereinafter, lower limit number information), information regarding a facility available in a hub, and the like. The facility available in a hub includes a charging device for charging a battery of the vehicle 2, the administrator terminal 4 disposed in a hub, and the like.

The vehicle information storage unit 112 stores information on the plurality of vehicles 2 (hereinafter, vehicle information) and state information indicating a state of the plurality of vehicles 2. The vehicle information includes identification information of the vehicle 2, information indicating a type of the vehicle 2, destination information for communication of the vehicle 2, a model number (model number) of the vehicle 2, information indicating a moving speed of the vehicle 2, and the like. Information indicating a vehicle type of the vehicle 2 includes information indicating whether the vehicle 2 is an automobile, a motorcycle, a motorized bicycle, or an electric bicycle, and information indicating a model number (model number) of the vehicle 2.

The movement history information storage unit 113 stores information (first information) indicating a history of movement using the plurality of vehicles 2 by a plurality of users. As described later, basically, every time the user uses the vehicle 2 once, the movement history information storage unit 113 stores information (hereinafter, movement history information) indicating a history of movement using the vehicle 2 by the user. That the user uses the vehicle 2 once indicates that the user moves using the vehicle 2 that the user rents in a certain hub and then returns the vehicle 2 at the same hub as the hub where the user rents the vehicle 2 or at another hub.

Specifically, the movement history information includes identification information of the user, identification information of the vehicle 2 used by the user for movement, a departure hub and a departure date and time of the vehicle 2, an arrival hub and an arrival date and time of the vehicle 2, weather at the departure date and time or the arrival date and time, a date category of a movement date of the vehicle 2, a month when the vehicle 2 moves, and information indicating a vehicle type of the vehicle 2.

The reaction history information storage unit 114 stores information (hereinafter, reaction history information (third information)) indicating a reaction when a plurality of users receive notification of movement request information and information indicating a reward to be paid to each user when a request indicated by the movement request information is achieved.

Specifically, the reaction history information includes identification information of the user, information indicating movement request information and a reward notified to the user, and information indicating whether or not the user has an intention of achieving a request indicated by the movement request information (hereinafter, reaction result information).

The communication circuit 11 communicates with the plurality of vehicles 2, the plurality of user terminals 3, the plurality of administrator terminals 4, and the public server 5 via the network 9.

The processor 13 includes a central processing unit (CPU). The processor 13 operates as an acquisition unit 131, an acceptance unit 132, an identification unit 133, a calculation unit 134, a determination unit 135, and a notification unit 136 by executing a program stored in the memory 10.

The acquisition unit 131 acquires various types of information received by the communication circuit 11 from the plurality of vehicles 2, the plurality of user terminals 3, and the plurality of administrator terminals 4. Further, the acquisition unit 131 stores, in the memory 10, information based on information acquired from the plurality of vehicles 2, the plurality of user terminals 3, and the plurality of administrator terminals 4 via the communication circuit 11.

Specifically, the acquisition unit 131 acquires vehicle information of the plurality of vehicles 2 shared in a sharing service received by the communication circuit 11 from the administrator terminal 4 and hub information regarding a plurality of hubs. The acquisition unit 131 stores the acquired vehicle information of the plurality of vehicles 2 in the vehicle information storage unit 112, and stores the acquired hub information regarding a plurality of hubs in the hub information storage unit 111. The acquisition unit 131 acquires state information indicating a current state of each of the vehicles 2 received by the communication circuit 11 from each of the vehicles 2, and stores the acquired state information in the vehicle information storage unit 112.

Further, the acquisition unit 131 acquires movement history information received by the communication circuit 11 from the administrator terminal 4, and stores the movement history information in the movement history information storage unit 113. Details of this processing will be described later.

Further, the acquisition unit 131 acquires reaction intention information received by the communication circuit 11 from the user terminal 3, and stores reaction history information based on the reaction intention information in the reaction history information storage unit 114. The reaction intention information is information indicating an intention to achieve a request indicated by movement request information. Details of this processing will be described later.

The acquisition unit 131 makes various inquiries to the public server 5 via the network 9 by using the communication circuit 11. Specifically, the acquisition unit 131 inquires of the public server 5 to return information indicating weather corresponding to a designated date and time and information indicating a date category of a designated date. The acquisition unit 131 uses the communication circuit 11 to acquire information indicating weather and information indicating a date category returned by the public server 5 in response to the inquiry.

The acceptance unit 132 accepts movement request information received by the communication circuit 11 from a server device of a system that predicts a charging status and demand of the plurality of vehicles 2 arranged in a plurality of hubs.

Note that in a case where an administrator requests a plurality of users to move the vehicle 2 from one hub to another hub, the administrator may operate the administrator terminal 4 to input movement request information indicating the request. In this case, when input operation of movement request information is finished, the administrator terminal 4 transmits the input movement request information to the server device 1 via the network 9. By the above, the acceptance unit 132 may accept movement request information received by the communication circuit 11 from the administrator terminal 4.

Further, the acceptance unit 132 may periodically refer to hub information stored in the hub information storage unit 111 and automatically generate movement request information indicating that the vehicle 2 is moved from a hub in which a number indicated by current number information is larger than a number indicated by lower limit number information to a hub in which a number indicated by current number information is smaller than a number indicated by lower limit number information so as to accept the movement request information.

Based on movement history information stored in the movement history information storage unit 113, the identification unit 133 identifies one or more users (hereinafter, target user) having a history of movement from a departure hub of the vehicle 2 indicated by movement request information accepted by the acceptance unit 132 to an arrival hub of the vehicle 2 indicated by the movement request information.

Specifically, the identification unit 133 extracts one or more pieces of movement history information including information indicating the same departure hub and arrival hub as a departure hub and an arrival hub of the vehicle 2 indicated by movement request information from movement history information stored in the movement history information storage unit 113. Then, the identification unit 133 identifies the user corresponding to identification information of the user included in each of the extracted one or more pieces of movement history information as a target user.

For each of one or more target users identified by the identification unit 133, the calculation unit 134 calculates a degree of coincidence (hereinafter, matching rate) between movement history information stored in the movement history information storage unit 113 and movement request information accepted by the acceptance unit 132. Details of processing in which the calculation unit 134 calculates a matching rate will be described later.

For each of one or more target users identified by the identification unit 133, the determination unit 135 outputs a price (hereinafter, presentation price) of a reward to be paid to each target user when each target user achieves a request indicated by movement request information accepted by the acceptance unit 132. Details of processing in which the determination unit 135 outputs a presentation price of each target user will be described later.

The notification unit 136 notifies each of one or more target users identified by the identification unit 133 of movement request information accepted by the acceptance unit 132 and information indicating a reward for each target user.

Specifically, using the communication circuit 11, the notification unit 136 transmits, to the user terminal 3 used by each of one or more target users identified by the identification unit 133, movement request information accepted by the acceptance unit 132 and information indicating a reward for each target user including information indicating a presentation price of each target user output by the determination unit 135.

### Flow of Processing of Storing Movement History Information

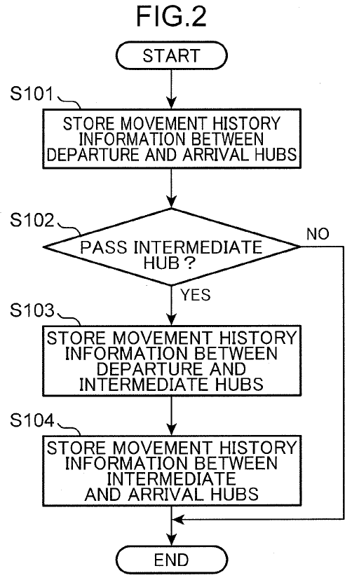

Next, details of processing in which the acquisition unit 131 acquires movement history information and stores the movement history information in the movement history information storage unit 113 will be described with reference to FIG. 2. FIG. 2 is a flowchart illustrating an example of processing of storing movement history information.

When the user moves from a departure hub to an arrival hub using the vehicle 2 and returns the vehicle 2 at the arrival hub, an administrator operates the administrator terminal 4 to input movement history information indicating a history that the user moves from the departure hub to the arrival hub of the vehicle 2 using the vehicle 2. When input operation of movement history information ends, the administrator terminal 4 transmits the input movement history information to the server device 1 via the network 9. By the above, the acquisition unit 131 acquires the movement history information received by the communication circuit 11 from the administrator terminal 4.

As illustrated in FIG. 2, when acquiring movement history information, the acquisition unit 131 stores the acquired movement history information in the movement history information storage unit 113 (step S101).

Next, the acquisition unit 131 determines whether or not the user passes through an intermediate hub present within a predetermined distance from the vehicle 2 while moving by using the vehicle 2 (step S102).

Specifically, in step S102, the acquisition unit 131 extracts, from the vehicle information storage unit 112, state information including identification information of the vehicle 2 included in the movement history information acquired in step S101 and including current date and time information indicating a date and time of a period from a departure date and time to an arrival date and time indicated by the movement history information. The acquisition unit 131 determines whether or not hub information including information indicating a position within the predetermined distance from a current position of the vehicle 2 indicated by the extracted state information as information indicating a position of a hub is stored in the hub information storage unit 111.

In a case of determining that the hub information is stored in the hub information storage unit 111, the acquisition unit 131 determines that the user passes through an intermediate hub corresponding to the hub information (YES in step S102). The intermediate hub corresponding to hub information is a hub indicated by identification information included in the hub information.

In this case, the acquisition unit 131 generates (acquires) movement history information indicating that the user moves from a departure hub indicated by the movement history information acquired in step S101 to the intermediate hub through which the user is determined to pass in step S102, and stores the movement history information in the movement history information storage unit 113 (step S103).

Specifically, in step S103, the acquisition unit 131 generates information in which information indicating an arrival hub and an arrival date and time included in the movement history information acquired in step S101 is changed to information indicating the intermediate hub through which the user is determined to pass in step S102 and a date and time of passing through the intermediate hub.

Note that the acquisition unit 131 refers to the state information including information indicating a position within a predetermined distance from a position of the intermediate hub extracted in step S102, and sets current date and time information included in the state information as information indicating a date and time of passing through the intermediate hub. However, the present invention is not limited to the above, and the acquisition unit 131 may set information indicating an intermediate date and time between a departure date and time and an arrival date and time indicated by the movement history information acquired in step S101 as information indicating a date and time of passing through an intermediate hub.

Next, the acquisition unit 131 generates movement history information indicating that the user moves from the intermediate hub through which the user is determined to pass in step S102 to an arrival hub indicated by the movement history information acquired in step S101, and stores the movement history information in the movement history information storage unit 113 (step S104).

Specifically, in step S104, similarly to step S103, the acquisition unit 131 generates movement history information in which the information indicating a departure hub and a departure date and time included in the movement history information acquired in step S101 is changed to information indicating an intermediate hub through which the user is determined to pass in step S102 and a date and time of passing through the intermediate hub.

Note that step S104 may be omitted. Alternatively, steps S102 to S104 may be omitted.

### Flow of Processing Performed in Vehicle Sharing System 100

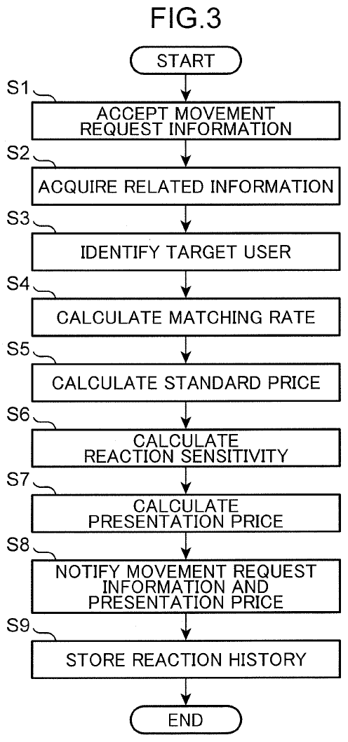

Next, processing performed in the vehicle sharing system 100 in a case where the acceptance unit 132 accepts movement request information will be described with reference to FIG. 3. FIG. 3 is a flowchart illustrating an example of processing performed in the vehicle sharing system 100 in a case where movement request information is acquired.

As illustrated in FIG. 3, when the acceptance unit 132 accepts movement request information (step S1), the acquisition unit 131 acquires information (hereinafter, related information) related to the movement request information acquired in step S1 (step S2).

The related information includes information indicating weather in a movement time zone of the vehicle 2 (hereinafter, weather information), information indicating a date category of a movement date of the vehicle 2 (hereinafter, date category information), information indicating a month when the vehicle 2 moves and a vehicle type of the vehicle 2 to be moved. As described above, the acquisition unit 131 acquires weather information and date category information from the public server 5. The acquisition unit 131 refers to vehicle information stored in the vehicle information storage unit 112 and acquires information indicating a vehicle type of the vehicle 2 to be moved.

Next, based on movement history information stored in the movement history information storage unit 113, the identification unit 133 identifies one or more target users having a history of movement from a departure hub of the vehicle 2 indicated by the movement request information acquired in step S1 to an arrival hub of the vehicle 2 indicated by the movement request information (step S3).

Next, the calculation unit 134 calculates a matching rate for each of one or more target users identified in step S3 (step S4). A method of calculating a matching rate of each target user in step S4 will be described later.

Next, the determination unit 135 calculates a standard price of a reward to be paid to a target user who achieves a request indicated by the movement request information acquired in step S1 (step S5). A method of calculating the standard price in step S5 will be described later.

Next, the calculation unit 134 calculates reaction sensitivity for each of all users (a plurality of users) of a sharing service based on reaction history information stored in the reaction history information storage unit 114 (step S6).

The reaction sensitivity indicates how high, among all the users, probability indicating that each user has an intention of achieving a request indicated by the movement request information acquired in step S1 is when all the users receive a notification of the standard price calculated in step S5 as a price of a reward. A method for calculating the reaction sensitivity in step S6 will be described later.

Note that step S6 may be omitted, and processing in and after step S7 may be performed with reaction sensitivities of all the users set to the same value.

Next, for each of one or more of the target users identified in step S3, the determination unit 135 calculates a presentation price of a reward to be notified to each target user based on the matching rate of each target user calculated in step S4, the standard price calculated in step S5, and the reaction sensitivities of all users calculated in step S6 (step S7). A method of calculating the presentation price of each target user in step S7 will be described later.

Next, the notification unit 136 notifies each of one or more of the target users identified in step S3 of the movement request information acquired in step Si and information indicating a reward for each target user including information indicating the presentation price of each target user calculated in step S7 (step S8).

Next, for each of one or more of the target users identified in step S3, the acquisition unit 131 stores reaction history information indicating a reaction when each target user receives the movement request information and the information indicating a reward notified in step S8 in the reaction history information storage unit 114 (step S9).

Specifically, when receiving the movement request information and the information indicating a reward notified in step S8, in a case where a target user has an intention of achieving a request indicated by the movement request information, the target user performs predetermined operation indicating that the target user has the intention on the user terminal 3. When this predetermined operation is performed, the user terminal 3 transmits reaction intention information indicating that the target user has the intention to the server device 1.

In step S9, in a case where the communication circuit 11 receives reaction intention information from the user terminal 3 of a certain target user by a movement time zone indicated by the movement request information input in step Si, the acquisition unit 131 acquires the reaction intention information. Then, the acquisition unit 131 generates reaction history information including identification information of the target user, information indicating the movement request information and the reward notified to the target user in step S8, and the acquired reaction intention information as reaction result information, and stores the generated reaction history information in the reaction history information storage unit 114.

On the other hand, in step S9, in a case where the communication circuit 11 does not receive reaction intention information from the user terminal 3 of a certain target user by a movement time zone indicated by the movement request information input in step S1, the acquisition unit 131 generates reaction result information indicating that the target user does not have an intention of achieving a request indicated by the movement request information. Then, the acquisition unit 131 generates reaction history information including identification information of the target user, information indicating the movement request information and the reward notified to the target user in step S8, and the generated reaction result information, and stores the generated reaction history information in the reaction history information storage unit 114.

### Method of Calculating Matching Rate

Next, a method of calculating a matching rate of each target user in step S4 (FIG. 3) will be described. Hereinafter, a method of calculating a matching rate of each target user will be described on the assumption that n pieces of movement history information are stored for each target user in the movement history information storage unit 113. The calculation unit 134 calculates, as a matching rate of each target user, how high a degree of coincidence between a comparison parameter (movement content of a vehicle) based on the n pieces of movement history information of each target user and a comparison parameter based on the movement request information acquired in step S1 is among one or more target users.

Specifically, first, the calculation unit 134 calculates a deviation degree between a comparison parameter based on n pieces of movement history information of each target user and a comparison parameter based on the movement request information acquired in step S1. The comparison parameter includes a use time zone, a departure hub, and an arrival hub of the vehicle 2. Hereinafter, a use time zone of the vehicle 2 is referred to as a first comparison parameter, a departure hub of the vehicle 2 is referred to as a second comparison parameter, and an arrival hub of the vehicle 2 is referred to as a third comparison parameter.

Specifically, the calculation unit 134 calculates a difference between a j-th comparison parameter Pⱼₖ based on k-th movement history information and a j-th comparison parameter P_{jd} based on movement request information for each of n pieces of movement history information of each target user U_{q} using Equation (1) below, and calculates an average value of the differences as the deviation degree A_{jq}.

[Mathematical formula 1]

A_{jq}=(Σₖ₌₁ⁿ|Pⱼₖ−P_{jd}|)/n (1)

For example, the calculation unit 134 substitutes a time at an intermediate point of time from a departure date and time of the vehicle 2 indicated by k-th movement history information of the target user U_{q} to an arrival date and time of the vehicle 2 indicated by the k-th movement history information into Pⱼₖ on the right side of Equation (1) as a first comparison parameter P₁ₖ based on the k-th movement history information. The calculation unit 134 substitutes a time at an intermediate point of time in a movement time zone indicated by movement request information into P_{jd} on the right side of Equation (1) as a first comparison parameter P_{1d} based on movement request information.

For example, it is assumed that a departure date and time of the vehicle 2 indicated by k-th movement history information of the target user U_{q} is “23:50 on Jun. 1, 2021” and an arrival date and time of the vehicle 2 is “0:50 on Jun. 2, 2021”. Further, it is assumed that a movement time zone indicated by movement request information is “23:00 on Jun. 15, 2021 to 0:00 on Jun. 16, 2021”.

In this case, the calculation unit 134 substitutes a time “0:20” at an intermediate point of time between the departure date and time and the arrival date and time into Pⱼₖ on the right side of Equation (1) as the first comparison parameter P₁ₖ based on k-th movement history information. The calculation unit 134 substitutes a time “23:30” at an intermediate point of time in a movement time zone included in movement request information into P_{jd} on the right side of Equation (1) as the first comparison parameter P_{1d} based on movement request information. Therefore, in this case, a difference between a j-th comparison parameter Pⱼ based on the k-th movement history information and the j-th comparison parameter Pⱼ based on the movement request information is “50 minutes (=0:20−23:30)”.

By the above, the calculation unit 134 calculates a deviation degree A_{1q} between a first comparison parameter P₁ (a use time zone of the vehicle 2) based on n pieces of movement history information of the target user U_{q} and the first comparison parameter P₁ based on movement request information. Hereinafter, the deviation degree A_{jq} between the j-th comparison parameter Pⱼ based on n pieces of movement history information of the target user U_{q} and the j-th comparison parameter Pⱼ based on movement request information is abbreviated as the deviation degree A_{jq} of the j-th comparison parameter Pⱼ of the target user U_{q}.

Note that information indicating a movement time zone included in movement request information may be one that does not include an arrival date and time of the vehicle 2 but includes only a departure date and time of the vehicle 2 (in the present example, “23:00 on Jun. 15, 2021”). In this case, the calculation unit 134 preferably refers to vehicle information stored in the vehicle information storage unit 112 and hub information stored in the hub information storage unit 111, grasps a moving speed of the vehicle 2 of a vehicle type indicated by movement request information and a distance from a departure hub to an arrival hub indicated by the movement request information, and calculates time required to move the vehicle 2 according to a request indicated by the movement request information. Then, the calculation unit 134 preferably calculates a date and time after the calculated time from a departure date and time of the vehicle 2 as an arrival date and time of the vehicle 2.

Alternatively, in a case where information indicating a movement time zone included in movement request information includes only a departure date and time of the vehicle 2, a time to be substituted into P_{jd} of Equation (1) may be a time of a departure date and time of the vehicle 2. In this case, as described above, the calculation unit 134 may calculate time required for the vehicle 2 of a vehicle type indicated by k-th movement history information to move from a departure hub to an arrival hub included in the k-th movement history information (hereinafter, movement time) based on vehicle information stored in the vehicle information storage unit 112 and hub information stored in the hub information storage unit 111. Then, the calculation unit 134 may substitute a time (for example, 9:30) before a departure date and time (for example, 10:00 on Jun. 1, 2021) of the vehicle 2 included in the k-th movement history information by calculated movement time (for example, 30 minutes) into Pⱼₖ in Equation (1).

Similarly, the calculation unit 134 substitutes a departure hub of the vehicle 2 included in k-th movement history information into Pⱼₖ on the right side of Equation (1) and substitutes a departure hub of the vehicle 2 included in movement request information to P_{jd} on the right side of Equation (1) to calculate a deviation degree A_{2q} of a second comparison parameter P₂ (departure hub of the vehicle 2) of the target user U_{q}. Similarly, the calculation unit 134 calculates a deviation degree A_{3q} of a third comparison parameter P₃ (arrival hub of the vehicle 2) of the target user U_{q} using Equation (1).

Similarly, for each of one or more of the target users identified in step S3 (FIG. 3), the calculation unit 134 calculates the deviation degrees A_{1q} to A_{3q} of the first to third comparison parameters P₁ to P₃ of each of the target users U_{q}.

Next, the calculation unit 134 calculates a relative degree D_{jq} of coincidence indicating how high a degree of coincidence between the j-th comparison parameter Pⱼ based on n pieces of movement history information of each of the target users U_{q} and the j-th comparison parameter Pⱼ based on movement request information is among the degrees of coincidence of all the target users by using the deviation degree A_{jq} of the j-th comparison parameter Pⱼ of each of the target users U_{q}. Hereinafter, the relative degree D_{jq} of coincidence is abbreviated as a relative degree D_{jq} of coincidence of the j-th comparison parameter Pⱼ of each of the target users U_{q}.

Specifically, the calculation unit 134 calculates the relative degree D_{jq} of coincidence of the j-th comparison parameter Pⱼ of each of the target users U_{q} by using Equation (2) including the deviation degree A_{jq} of the j-th comparison parameter Pⱼ of each of the target users U_{q} calculated by using Equation (1).

$$\begin{matrix}[ Mathematical formula 2 ] & \\ {D}_{jq} = \frac{1 - ( {A}_{jq} - {A}_{j \_ min} )}{{A}_{j \_ max} - {A}_{j \_ min}} \times 100 \% & ( 2 )\end{matrix}$$

In Equation (2), A_{j_min} represents a minimum value among the deviation degrees A_{jq} of the j-th comparison parameters Pⱼ of all target users. A_{j_max} indicates a maximum value among the deviation degrees A_{jq} of the j-th comparison parameter Pⱼ of all target users. That is, according to Equation (2), the smaller the deviation degree A_{jq} of the j-th comparison parameter Pⱼ of the target user U_{q}, the larger the relative degree D_{jq} of coincidence of the j-th comparison parameter Pⱼ of the target user U_{q}. For this reason, among all target users, the relative degree D_{jq} of coincidence of the j-th comparison parameter Pⱼ of the target user U_{q} whose deviation degree A_{jq} of the j-th comparison parameter Pⱼ is the minimum value A_{j_min} is 100%.

Note that the calculation unit 134 may further calculate an average value of the deviation degrees A_{jq} of the j-th comparison parameters Pⱼ of all target users as an average deviation degree A_{j_ave} of the j-th comparison parameters Pⱼ. In this case, the calculation unit 134 may exclude the target user U_{q} whose deviation degree A_{jq} of the j-th comparison parameter Pⱼ is larger than the average deviation degree A_{j_ave} of the j-th comparison parameter Pⱼ from a target user in the processing of step S5 and subsequent steps.

As described above, the calculation unit 134 calculates relative degrees D_{1q} to D_{3q} of coincidence of the first to third comparison parameters P₁ to P₃ of each of the target users U_{q} for all target users.

Next, the calculation unit 134 uses related information included in movement history information and related information related to the movement request information acquired in step S2 (FIG. 2) as comparison parameters, and calculates the relative degree D_{jq} of coincidence of the j-th comparison parameter Pⱼ of each of the target users U_{q} using Equation (3).

As described above, the related information includes information indicating weather in a movement time zone of the vehicle 2 (weather when the vehicle moves), a date category of a movement date of the vehicle 2, a month when the vehicle 2 moves, and a vehicle type of the vehicle 2. Hereinafter, weather in a movement time zone of the vehicle 2 is referred to as a fourth comparison parameter P₄, a date category of a movement date of the vehicle 2 is referred to as a fifth comparison parameter P₅, a month when the vehicle 2 moves is referred to as a sixth comparison parameter P₆, and a vehicle type of the vehicle 2 is referred to as a seventh comparison parameter P₇.

$$\begin{matrix}[ Mathematical formula 3 ] & \\ {D}_{jq} = \frac{{B}_{jq} - {B}_{j \_ min}}{{B}_{j \_ max} - {B}_{j \_ min}} \times 100 \% & ( 3 )\end{matrix}$$

In Equation (3), B_{jq} indicates a degree of coincidence between the j-th comparison parameter Pⱼ related to n pieces of movement history information of each of the target users U_{q} and the j-th comparison parameter Pⱼ related to movement request information. Hereinafter, the degree B_{jq} of coincidence between the j-th comparison parameter Pⱼ related to n pieces of movement history information of each of the target users U_{q} and the j-th comparison parameter Pⱼ related to movement request information is abbreviated as the degree B_{jq} of coincidence of the j-th comparison parameter Pⱼ of each of the target users U_{q}.

In Equation (3), B_{j_max} represents a maximum value among the degrees B_{jq} of coincidence of the j-th comparison parameters Pⱼ of all target users, and B_{j_min} represents a minimum value among the degrees B_{jq} of coincidence of the j-th comparison parameter Pⱼ of all target users. That is, according to Equation (3), the larger the degree B_{jq} of coincidence of the j-th comparison parameter Pⱼ of the target user U_{q}, the larger the relative degree D_{jq} of coincidence of the j-th comparison parameter Pⱼ of the target user U_{q}. For this reason, among all target users, the relative degree D_{jq} of coincidence of the j-th comparison parameter Pⱼ of the target user U_{q} whose degree B_{jq} of coincidence of the j-th comparison parameter Pⱼ is the maximum value B_{j_max} is 100%.

Note that the calculation unit 134 may further calculate an average value of the degrees B_{jq} of coincidence of the j-th comparison parameters Pⱼ of all target users as an average degree B_{j_ave} of coincidence of the j-th comparison parameters Pⱼ. In this case, the calculation unit 134 may exclude the target user U_{q} whose degree B_{jq} of coincidence of the j-th comparison parameter Pⱼ is smaller than the average degree B_{j_ave} of coincidence of the j-th comparison parameter Pⱼ from a target user in the processing of step S5 and subsequent steps.

For example, in a case of calculating a relative degree D_{4q} of coincidence of the fourth comparison parameter P₄ of each of the target users U_{q}, the calculation unit 134 refers to movement history information (hereinafter, movement history information of the previous month) stored in the previous month among n pieces of movement history information of the target user U_{q}.

The calculation unit 134 calculates, as the degree B_{4q} of coincidence of the fourth comparison parameter P₄ (weather) of each of the target users U_{q}, the number of pieces of movement history information in which weather at a departure date and time or an arrival date and time matches weather in a movement time zone of the vehicle 2 indicated by the related information acquired in step S2 in movement history information of the previous month. Similarly, the calculation unit 134 calculates the degree B_{4q} of coincidence of the fourth comparison parameter P₄ of each of the target users U_{q} for all target users.

The calculation unit 134 substitutes the degree B_{4q} of coincidence of the fourth comparison parameter P₄ of each of the target users U_{q} into B_{jq} on the right side of Equation (3). The calculation unit 134 sets a minimum value of the degrees B_{4q} of coincidence of the fourth comparison parameters P₄ of all target users as B_{4_min}, and further substitutes B_{4_min} into B_{j_min} on the right side of Equation (3). The calculation unit 134 sets a maximum value of the degrees B_{jq} of coincidence of the fourth comparison parameters P₄ of all target users as B_{4_max}, and further substitutes B_{4_max} into B_{j_max} on the right side of Equation (3). The calculation unit 134 calculates the relative degree D_{4q} of coincidence of the fourth comparison parameter P₄ of each of the target users U_{q} by Equation (3) after the above substitution.

Similarly, the calculation unit 134 calculates relative degrees D_{5q} to D_{7q} of coincidence of the fifth to seventh comparison parameters P₅ to P₇ of each of the target users U_{q}.

Note that in a case of calculating the relative degree D_{5q} of coincidence of the fifth comparison parameter P₅ of each of the target users U_{q}, the calculation unit 134 calculates, as the degree B_{5q} of coincidence of the fifth comparison parameter P₅ (date category) of each of the target users U_{q}, the number of pieces of movement history information in which a date category of a movement date of the vehicle 2 coincides with a date category of a movement date of the vehicle 2 indicated by related information in movement history information of the previous month.

In a case of calculating a relative degree D_{6q} of coincidence of the sixth comparison parameter P₆ of each of the target users U_{q}, the calculation unit 134 refers to movement history information of the most recent one year among n pieces of movement history information of the target user U_{q}. The calculation unit 134 calculates, as the degree B_{6q} of coincidence of the sixth comparison parameter P₆ (month) of each of the target users U_{q}, the number of pieces of movement history information in which a month when the vehicle 2 moves coincides with a month when the vehicle 2 moves indicated by related information among pieces of movement history information for the most recent one year.

In a case of calculating a relative degree D_{7q} of coincidence of the seventh comparison parameter P₇ of each of the target users U_{q}, the calculation unit 134 calculates the number of pieces of movement history information in which a vehicle type of the vehicle 2 matches a vehicle type of the vehicle 2 indicated by related information among pieces of movement history information of the previous month as the degree B_{7q} of coincidence of the seventh comparison parameter P₇ (vehicle type) of each of the target users U_{q}.

Then, the calculation unit 134 calculates a weighted average value of the relative degrees D_{1q} to D_{7q} of the first to seventh comparison parameters P₁ to P₇ of each of the target users U_{q} as a matching rate M_{q} of each of the target users U_{q} as illustrated in Equation (4) below.

[Mathematical formula 4]

M_{q}=(Σₖ₌₁⁷(Wₖ×D_{kq}))/Σₖ₌₁⁷Wₖ (4)

In Equation (4), W₁ to W₇ are weighting factors of the relative degrees D_{1q} to D_{7q} of coincidence. The weighting factors W₁ to W₇ are set to an optional value of zero or more such that at least one of the weighting factors W₁ to W₇ has a value larger than zero. For example, the first to third weighting factors W₁ to W₃ may be set to a value larger than zero, and the fourth to seventh weighting factors W₄ to W₇ may be set to zero. Further, the first to third weighting factors W₁ to W₃ may be set to a value larger than zero, at least one of the fourth to seventh weighting factors W₄ to W₇ may be set to a value larger than zero, and the others of the fourth to seventh weighting factors W₄ to W₇ may be set to zero.

### Standard Price Calculation Method

Next, a method of calculating a standard price of a reward to be paid to a target user who achieves a request indicated by movement request information in step S5 (FIG. 3) will be described.

Specifically, the determination unit 135 determines the standard price by using information indicating a vehicle type, a departure hub, and an arrival hub of the vehicle 2 included in movement request information, and a price calculation table. The price calculation table is a table in which a vehicle type of the vehicle 2 is associated with a price of a reward to be paid in a case where the user moves the vehicle 2 of the vehicle type by a predetermined unit distance, and is stored in advance in the memory 10.

In step S5, the determination unit 135 refers to a price calculation table stored in the memory 10, and acquires a price of a reward associated with a vehicle type of the vehicle 2 indicated by movement request information. The determination unit 135 calculates a distance from a departure hub to an arrival hub indicated by movement request information based on hub information stored in the hub information storage unit 111. The determination unit 135 determines the product of the acquired price of the reward and the distance from a departure hub to an arrival hub as a standard price.

Furthermore, the determination unit 135 may adjust a standard price according to a movement time zone indicated by movement request information, and weather in a movement time zone of the vehicle 2, a date category of a movement date of the vehicle 2, a month when the vehicle 2 moves, and a vehicle type of the vehicle 2 to be moved indicated by the related information acquired in step S2.

For example, one day is divided into 24 time zones in units of one hour, and an adjustment coefficient (hereinafter, a first adjustment coefficient) is determined in advance in a predetermined range (for example, 0.1 to 3.0) for each time zone. Further, an adjustment coefficient (hereinafter, a second price adjustment coefficient) is determined in advance within a predetermined range for each of sunny, rainy, cloudy, and other weather. Similarly, an adjustment coefficient (third price adjustment coefficient) is determined in advance in a predetermined range for each of eight types of date categories, an adjustment coefficient (hereinafter, a fourth adjustment coefficient) is determined in advance in a predetermined range for each month from January to December, and an adjustment coefficient (hereinafter, a fifth adjustment coefficient) is determined in advance in a predetermined range for each vehicle type. Note that the predetermined range may be a range different for each adjustment coefficient, or may be the same range between a plurality of adjustment coefficients.

Then, the determination unit 135 may adjust a standard price by multiplying the calculated standard price by at least one or more adjustment coefficients of the first to fifth adjustment coefficients.

### Reaction Sensitivity Calculation Method

Next, a method of calculating a reaction sensitivity for each of all users of a sharing service in step S6 (FIG. 3) will be described.

First, the calculation unit 134 refers to, among pieces of reaction history information of each user stored in the reaction history information storage unit 114, reaction history information (hereinafter, target reaction history information) including reaction result information indicating that the user has an intention of achieving a request indicated by movement request information. In description below, the calculation unit 134 refers to m pieces of target reaction history information.

The calculation unit 134 calculates a deviation degree between the standard price calculated in step S5 (FIG. 3) and a presentation price indicated by m pieces of target reaction history information of each user. Specifically, the calculation unit 134 calculates a difference between a standard price V_{d} calculated in step S5 (FIG. 3) and a presentation price Vₖ included in k-th target reaction history information for each of m pieces of target reaction history information of each of the users U_{q} by using Equation (5) below, and calculates an average value of the differences as the deviation degree C_{q}.

[Mathematical formula 5]

C_{q}=(Σₖ₌₁^{m}(V_{d}−Vₖ))/m (5)

Hereinafter, the deviation degree C_{q} between the standard price V_{d} calculated in step S5 and a presentation price included in m pieces of target reaction history information of the user U_{q} is described as the deviation degree C_{q} of a reaction price of the user U_{q}. Similarly, the calculation unit 134 calculates the deviation degree C_{q} of a reaction price of each of the users U_{q} for all users.

Next, the calculation unit 134 calculates a reaction sensitivity R_{q} of each of the users U_{q} for all users by using Equation (6) below including the deviation degree C_{q} of a reaction price of each of the users U_{q}.

$$\begin{matrix}[ Mathematical formula 6 ] & \\ {R}_{q} = \frac{{C}_{q} - {C}_{min}}{{C}_{max} - {C}_{min}} \times 100 \% & ( 6 )\end{matrix}$$

In Equation (6), Cₘᵢₙ represents a minimum value among the deviation degrees C_{q} of reaction prices of all users. Cₘₐₓ represents a maximum value among the deviation degrees C_{q} of reaction prices of all users. That is, according to Equation (6), the reaction sensitivity R_{q} of the user U_{q} increases as the deviation degree C_{q} of a reaction price of the user U_{q} increases.

Note that the calculation unit 134 may further calculate an average value (hereinafter, average deviation degree of a reaction price) Cₐᵥₑ of the deviation degrees C_{q} of reaction prices of all users. In this case, in a case where the user U_{q} whose deviation degree C_{q} of a reaction price is smaller than the average deviation degree Cₐᵥₑ of a reaction price is the target user identified in step S3 (FIG. 3), the calculation unit 134 may exclude the user U_{q} from a target user in the processing of step S7 (FIG. 3) and subsequent steps.

### Method of Calculating Presentation Price

Next, a method of calculating a presentation price of each of the target users U_{q} in step S7 (FIG. 3) will be described.

It is assumed that a target user having the matching rate M_{q} of 50% and the reaction sensitivity R_{q} of 50% is notified of information indicating the standard price V_{d} calculated in step S5 (FIG. 3) as information indicating a presentation price. In this case, it is assumed that the target user who receives the notification shows an intention to achieve a request indicated by movement request information with a probability indicated by an average value of reaction sensitivities of all users calculated in step S6 (FIG. 3).

Under the assumption, as illustrated in Equation (7) below, a probability (hereinafter, a reaction rate of each of the target users U_{q}) E_{q} that each of the target users U_{q} is predicted to have an intention to achieve a request indicated by movement request information can be expressed by the product of the average value Rₐᵥₑ of reaction sensitivities of all users calculated in step S6 and an adjustment coefficient γ larger than zero.

[Mathematical formula 7]

E_{q}=Rₐᵥₑ×γ (7)

On the other hand, it is considered that the reaction rate E_{q} of each of the target users U_{q} varies depending on the matching rate M_{q} of each of the target users U_{q} calculated in step S4 (FIG. 3), the reaction sensitivity R_{q} of each of the target users U_{q} calculated in step S5 (FIG. 3), and a presentation price of a reward to be paid to each of the target users U_{q} when a request indicated by movement request information is achieved.

Therefore, the reaction rate E_{q} of each of the target users U_{q} can also be expressed by the product of a weighted average value of the matching rate M_{q} and the reaction sensitivity R_{q} of each of the target users U_{q} and a discount rate F_{q} of the standard price V_{d} applied to each of the target users U_{q}, as shown in Equation (8) below. Hereinafter, the discount rate F_{q} of the standard price V_{d} applied to each of the target users U_{q} is abbreviated as the discount rate F_{q} for each of the target users U_{q}.

$$\begin{matrix}[ Mathematical formula 8 ] & \\ {E}_{q} = \frac{( α \times {M}_{q} + β \times {R}_{q} )}{( α + β )} \times {F}_{q} & ( 8 )\end{matrix}$$

In Equation (8), α represents a weighting factor of the matching rate M_{q} of each of the target users U_{q} larger than zero. β indicates a weighting factor of the reaction sensitivity R_{q} of each of the target users U_{q} larger than zero.

Equations (7) and (8) are equations indicating the reaction rate E_{q} of each of the target users U_{q}. In view of the above, the right side of Equation (7) is substituted into the left side of Equation (8), and the equation after the substitution is transformed, so as to obtain Equation (9) below for calculating the discount rate F_{q} for each of the target users U_{q}. In view of the above, in step S7 (FIG. 3), the determination unit 135 calculates the discount rate F_{q} for each of the target users U_{q} by using Equation (9) below.

$$\begin{matrix}[ Mathematical formula 9 ] & \\ {F}_{q} = \frac{( α + β ) \times {R}_{ave} \times γ}{( α \times {M}_{q} + β \times {R}_{q} )} & ( 9 )\end{matrix}$$

Further, in step S7 (FIG. 3), the determination unit 135 calculates a discount rate Fₐₗₗ of the standard price V_{d} to be applied to all target users by using Equation (10) below so that a total value of the reaction rates E_{q} of all target users calculated by using Equation (7) under the above assumption becomes equal to a desired reaction rate E_{d} indicated by the movement request information acquired in step S1 (FIG. 3). Hereinafter, the discount rate Fₐₗₗ of the standard price V_{d} applied to all target users is abbreviated as the discount rate Fₐₗₗ for all target users.

[Mathematical formula 10]

Fₐₗₗ=E_{d}/Σ_{q=1}^{N}E_{q} (10)

In Equation (10), N represents a total number of target users.

Then, in step S7 (FIG. 3), as shown in Equation (11) below, the determination unit 135 calculates the product of the standard price V_{d} calculated in step S5 (FIG. 3), the discount rate F_{q} for each of the target users U_{q} calculated using Equation (9), and the discount rate Fₐₗₗ for all target users calculated using Equation (10) as the presentation price I_{q} to be presented to each of the target users U_{q}.

[Mathematical formula 11]

I_{q}=V_{d}×F_{q}×Fₐₗₗ (11)

Further, in step S7 (FIG. 3), as shown in Equation (12) below, the determination unit 135 recalculates the product of the reaction rates E_{q} of all target users calculated using Equation (7) under the above assumption and the discount rate Fₐₗₗ calculated using Equation (10) as the reaction rate E_{q} of each of the target users U_{q}.

[Mathematical formula 12]

E_{q}=Rₐᵥₑ×γ×Fₐₗₗ (12)

That is, according to Equation (9), the discount rate F_{q} for the target user U_{q} is calculated to be lower as the target user U_{q} has the higher matching rate M_{q} and the higher reaction sensitivity R_{q}. By the above, according to Equation (11), the lower the presentation price I_{q} is calculated as the target user U_{q} has the higher matching rate M_{q} and the higher reaction sensitivity R_{q}.

For this reason, information indicating the low presentation price I_{q} can be notified to the target user U_{q} who has many movement histories with content close to movement content of the vehicle 2 based on movement request information and is highly likely to have an intention of achieving a request indicated by the movement request information. As a result, a price of a reward can be kept low, and an achievement rate of a request for moving the vehicle 2 can be increased at low cost.

On the other hand, according to Equation (9), the discount rate F_{q} for the target user U_{q} is calculated to be higher as the target user U_{q} has the lower matching rate M_{q} and the lower reaction sensitivity R_{q}. By the above, according to Equation (11), the higher the presentation price I_{q} is calculated as the target user U_{q} has the lower matching rate M_{q} and the lower reaction sensitivity R_{q}.

For this reason, information indicating the high presentation price I_{q} can be notified to the target user U_{q} who has a few movement histories with content close to movement content of the vehicle 2 based on movement request information and is less likely to have an intention of achieving a request indicated by the movement request information. By the above, even in a case where the user is notified of movement request information indicating a request for moving the vehicle 2 along a route where the user does not usually move, the user can have an increased intention to achieve the request for a reward of the high presentation price I_{q}. As a result, an achievement rate of a request for moving the vehicle 2 can be increased.

### Second Embodiment

Hereinafter, a second embodiment of the present disclosure will be described. In the first embodiment, an example in which a presentation price is individually calculated for each of one or more target users having a history of movement from a departure hub of the vehicle 2 indicated by movement request information to an arrival hub of the vehicle 2 indicated by the movement request information, and the movement request information and information indicating a reward of the presentation price are notified to each target user.

In the second embodiment, a price of a reward for a request indicated by movement request information is determined by what is called an auction. That is, in the second embodiment, a provisional price is notified to one or more target users as a price of a reward, and a target user who shows an intention to achieve a request indicated by movement request information for a reward at a lowest price is requested to move the vehicle 2 indicated by the movement request information with the reward at the lowest price.

Specifically, in step S7 (FIG. 3), instead of calculating the presentation price I_{q} of each of the target users U_{q} using Equation (11), the determination unit 135 calculates a provisional price Iₐₗₗ of a reward to be paid to each of the target users U_{q} by using Equation (13) below.

[Mathematical formula 13]

Iₐₗₗ=V_{d}×Fₐₗₗ (13)

Then, in step S8 (FIG. 3), the notification unit 136 notifies each of one or more target users identified in step S3 (FIG. 3) of auction holding information including the movement request information acquired in step S1 (FIG. 3) and information indicating a reward at the provisional price Iₐₗₗ determined in step S7. Note that the information indicating a reward at the provisional price Iₐₗₗ includes information indicating the provisional price Iₐₗₗ as information indicating a price of a reward.

Specifically, the auction holding information is information for guiding that an auction for determining the user who bids a lowest price equal to or less than the provisional price Iₐₗₗ as the user who is requested to move the vehicle 2 indicated by movement request information is held for a certain period. Note that the certain period only needs to be a period shorter than a period from notification of the auction holding information to a movement time zone indicated by movement request information.

It is assumed that within the certain period from notification of auction holding information by the notification unit 136, the communication circuit 11 receives information indicating acceptance of a request indicated by movement request information at a price equal to or less than the provisional price Iₐₗₗ from a predetermined number or more of users. The predetermined number only needs to be one or more. In this case, the notification unit 136 determines a lowest price among prices equal to or less than the provisional price Iₐₗₗ received by the communication circuit 11 as a price of a reward to be paid to the user when the request indicated by the movement request information is achieved.

Then, the notification unit 136 notifies the user who transmits the information indicating acceptance of a request indicated by movement request information at the lowest price of the movement request information and information indicating a reward at the lowest price. Note that the information indicating a reward at the lowest price includes information indicating the lowest price as information indicating a price of a reward.

As described above, in a configuration of the second embodiment, the user who transmits information indicating acceptance of a request indicated by movement request information at a lowest price equal to or less than the provisional price Iₐₗₗ is notified of the movement request information and information indicating a reward at the lowest price. For this reason, movement of the vehicle 2 indicated by movement request information can be achieved at low cost.

Note that, in step S8 (FIG. 3), the notification unit 136 may be configured to notify auction holding information only to the user whose reaction rate, matching rate, or reaction sensitivity is equal to or more than a predetermined value among one or more target users. In this case, it is possible to avoid transmitting auction holding information to the user who is predicted not to have an intention of achieving a request indicated by movement request information and whose reaction rate, matching rate, and reaction sensitivity are all less than the predetermined value.

Further, in the present disclosure, the first embodiment and the second embodiment described above may be optionally combined.

### INDUSTRIAL APPLICABILITY

According to the present disclosure, since an achievement rate of movement work of a vehicle to another hub can be increased at low cost, it is useful for providing a sharing service that allows a plurality of users to share a plurality of vehicles arranged in a plurality of hubs.

1. A control method in a system that allows a plurality of users to share a plurality of vehicles arranged in a plurality of hubs, the control method comprising:
by a computer,
acquiring first information indicating a history of movement between hubs using the plurality of vehicles by the plurality of users;
accepting second information indicating a request to move a vehicle from one hub to another hub;
outputting a price of a reward to be paid to each of the users when a request indicated by the second information is achieved, in accordance with a matching rate calculated as a degree of coincidence between the first information of each user and the second information; and
notifying of the second information and information indicating the reward of each user.

2. The control method according to claim 1, further comprising:
identifying one or more users having a history of movement from the one hub to the other hub based on the first information; and
calculating, as the matching rate, for each of the one or more users, how high a degree of coincidence between movement content of a vehicle by each user based on the first information and the movement content of a vehicle based on the second information is among the one or more users,
wherein
in the notification,
each of the one or more users is notified of the second information and information indicating the reward of each user.

3. The control method according to claim 2, wherein
a price of the reward is lower price as the matching rate is higher.

4. The control method according to claim 2, wherein
in the notification, a provisional price is notified as a price of the reward, and
further, in a case where information indicating acceptance of a request indicated by the second information at a price equal to or less than the provisional price is received from a predetermined number or more of users within a certain period from the notification, a lowest price among received prices equal to or less than the provisional price is determined as a price of the reward, and the second information and information indicating the reward are notified to the user who transmits information indicating acceptance of a request indicated by the second information at the lowest price.

5. The control method according to claim 4, further comprising:
acquiring third information indicating a reaction when the plurality of users receive a notification of the second information and information indicating the reward for each user;
calculating, for each of the plurality of users, a reaction sensitivity indicating how high among the plurality of users a probability indicating that each user has an intention of achieving a request indicated by the second information is when the plurality of users receive a notification of a predetermined standard price as a price of the reward based on the third information; and
calculating, for each of the plurality of users, a reaction rate that is a probability that a user is predicted to have an intention of achieving a request indicated by the second information, based on the matching rate and the reaction sensitivity,
wherein
in the notification,
a user who has any one of the reaction rate, the matching rate, and the reaction sensitivity equal to or more than a predetermined value among the one or more users is notified of the second information and information indicating the reward.

6. The control method according to claim 1, further comprising:
acquiring third information indicating a reaction when the plurality of users receive a notification of the second information and information indicating the reward for each user; and
calculating, for each of the plurality of users, a reaction sensitivity indicating how high among the plurality of users a probability indicating that each user has an intention of achieving a request indicated by the second information is when the plurality of users receive a notification of a predetermined standard price as a price of the reward based on the third information,
wherein
in the output of a price of the reward,
a price of the reward is further determined to be lower price as the reaction sensitivity of each user is higher.

7. The control method according to claim 1, wherein
in the acquisition of the first information,
in a case where a user passes through an intermediate hub existing within a predetermined distance from a vehicle while moving from the one hub to the other hub by using that vehicle, information indicating that the user moves from the one hub to the other hub by using that vehicle and information indicating that the user moves from the one hub to the intermediate hub by using that vehicle are acquired as the first information.

8. The control method according to claim 7, wherein
in the acquisition of the first information,
in a case where a user passes through an intermediate hub existing within a predetermined distance from a vehicle while moving from the one hub to the other hub by using that vehicle, information indicating that the user moves from the intermediate hub to the other hub by using that vehicle is further acquired as the first information.

9. The control method according to claim 1, wherein
the first information includes information indicating a departure hub and a departure date and time of a vehicle used by the plurality of users for movement, and information indicating an arrival hub and an arrival date and time of a vehicle used by the plurality of users for movement,
the second information further includes information indicating a time zone in which a vehicle is moved, and
the movement content of a vehicle includes a use time zone, a departure hub, and an arrival hub of a vehicle.

10. The control method according to claim 9, wherein
the movement content of a vehicle further includes at least one of weather when a vehicle moves, a date category of a movement date of a vehicle, a month when a vehicle moves, and a vehicle type of a vehicle, and
the date category is information indicating which of seven days of a week from Sunday to Saturday or a national holiday the date is.

11. A non-transitory computer readable storage medium storing a program that causes a computer included in a system that allows a plurality of users to share a plurality of vehicles arranged in a plurality of hubs to function as:
an acquisition unit that acquires first information indicating a history of movement between hubs using the plurality of vehicles by the plurality of users;
an acceptance unit that accepts second information indicating a request for moving a vehicle from one hub to another hub;
a determination unit that outputs a price of a reward to be paid to each of the users when a request indicated by the second information is achieved according to a matching rate calculated as a degree of coincidence between the first information of each user and the second information; and
a notification unit that notifies of the second information and information indicating the reward of each user.

12. A server device included in a system that allows a plurality of users to share a plurality of vehicles arranged in a plurality of hubs, the server device comprising:
an acquisition unit that acquires first information indicating a history of movement between hubs using the plurality of vehicles by the plurality of users;
an acceptance unit that accepts second information indicating a request for moving a vehicle from one hub to another hub;
a determination unit that outputs a price of a reward to be paid to each of the users when a request indicated by the second information is achieved according to a matching rate calculated as a degree of coincidence between the first information of each user and the second information, and
a notification unit that notifies of the second information and information indicating the reward of each user.
